(19) United States
(12) Patent Application Publication
(10) Pub. No.: US 2006/0078273 A1
(43) Pub. Date: Apr. 13, 2006

(54) Promotional materials derived from digital cinema data stream

(75) Inventors: John R. Fredlund, Rochester, NY (US); David L. Patton, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/960,828

(22) Filed: Oct. 7, 2004

(51) Int. Cl. H04N 5/76; H04N 5/225

(52) U.S. Cl. 386/46; 386/125; 386/117

(57) ABSTRACT

A method provides, at an exhibition site, a promotional item formed using motion picture data. The method uses the steps of receiving a motion picture data stream at the exhibition site, wherein the data stream is encoded to define at least one recordable portion (92) and storing the at least one recordable portion (92) of the motion picture data stream at the exhibition site. The method further uses the step of forming the promotional item according to the at least one recordable portion of the data stream, in response to a user command.

### FIELD OF THE INVENTION

This invention generally relates to digital cinema and more particularly relates to a method and apparatus for deriving data for forming supplemental promotional items from the digital data stream.

### BACKGROUND OF THE INVENTION

With the advent of digital cinema, considerable attention has been directed to potential commercial advantages that become available when using content that is generated and transmitted electronically. For example, digital cinema provides the capability to provide multiple versions of a movie or of movie scenes, as well as the capability to adapt the content of individual scenes based on audience demographics. Because the content of the motion picture and its associated advertising is transmitted electronically, there is additional flexibility for control of content, allowing opportunities for adapting displayed content to local conditions and audience preferences. Other technical advantages will allow more flexible display arrangements as well as opportunity for color enhancement and other imaging improvements. In addition to these technical and performance advantages, there also appear to be considerable advantages and opportunities for more economical motion picture distribution, for improved adaptation to markets and viewer demographics, for local customization of some types of content, and for an overall development of a more engrossing theater experience. Along with these advantages come enhanced opportunities for revenue enhancement both for studios that produce and distribute motion picture content and for theaters that display this content to audiences.

The conventional model for motion picture film distribution is characterized by rigid control of the entire distribution and display process, allowing minimal or no flexibility for local adaptation. Referring to FIG. 1, there is shown a block diagram of a conventional prior art motion picture film distribution system 10. A production studio 20 takes the content from content providers 22 who generate the film feature, advertising, trailers, previews, and other content for theater display, typically as separate content films 30. Studio 20 edits, masters, and prepares print films 24 and provides them, through a distribution network 26 to theaters 28. In the conventional model of FIG. 1, studio 20 dictates what is viewed at each theater 28. This control of what gets shown extends not only to the film feature itself, but also to any advertising or trailers, such as previews for future offerings, and the like. In the conventional arrangement, theaters 28 follow the instructions of studio 20 for display of the film feature and other related content. With the relatively inflexible arrangement shown in FIG. 1, there is no opportunity for dynamically adding or changing image content.

Theater revenues are primarily from admission fees and concession sales, often with some additional revenue from local and national advertisers for material displayed between showings. Theaters, however, have little participation in additional profits from movie-related items. Items that promote the motion picture and its stars include such items as posters, T-shirts, and other accessories. These promotional items are sold by stores and other outlets not related to the theater. Thus, while studios and motion picture distributors enjoy a share of the profits from sales of supplemental promotional items to movie fans, the theater does not derive any direct benefit from these sales.

It is well known that many consumers are more likely to purchase various types of items on impulse, based on experiencing an event such as a motion picture. Theater owners, however, are largely unable to take advantage of the type of consumer enthusiasm that often follows the viewing of a popular motion picture. Among practical obstacles are the cost of inventory, complexities of ordering and inventory management, required floor and storage space, and theft and security considerations. Thus, while it can be appreciated that the capability for offering promotional items to the movie audience would have advantages for movie theater owners, workable schemes for taking advantage of this opportunity have not been developed.

Items promoting a movie, such as posters and banners, are currently provided to the theater owner in printed form. These items can be expensive to ship and may not arrive in sufficient time for advertising an upcoming feature to current customers. Many motion picture fans would have an interest in purchasing movie posters, as provided to the theater or in personalized form. However, using conventional distribution practices, theater owners are not able to print their own posters for display, nor can they take advantage of potential revenues from the sale of these items.

Other revenue possibilities could be obtained from sales of items that include key portions of the motion picture content, including soundtrack audio. For example, many moviegoers would be favorably disposed to purchase the movie soundtrack following the showing. Using conventional distribution methods, however, it may be too costly or cumbersome for theater management to stock, manage, and sell quantities of conventionally produced CDs, DVDs, or other recorded materials for current films.

Thus, it can be seen that there is a need for solutions that allow a theater owner to print posters for advertisement and to provide other promotional cinema-related items to audiences in a timely and flexible fashion, without incurring high inventory expenses.

### SUMMARY OF THE INVENTION

The aforementioned needs are met with the present invention by a method providing, at an exhibition site, a promotional item formed using motion picture data, the method comprising the steps of:
(a) receiving a motion picture data stream at the exhibition site, wherein the data stream is encoded to define at least one recordable portion;
(b) storing the at least one recordable portion of the motion picture data stream at the exhibition site;
(c) forming the promotional item according to the at least one recordable portion of the data stream, in response to a user command.

Another aspect of the present invention provides a method of selective encoding of a motion picture data stream, comprising the steps of identifying at least one recordable segment of the data stream and identifying at least one non-recordable segment of the data stream.

Still another aspect of the present invention employs a method for providing a copy of a motion picture, comprising the steps of:
(a) receiving a motion picture data stream at an exhibition site, wherein the data stream is encoded to define a plurality of recordable scenes;
(b) processing the data for the plurality of recordable scenes from the data stream to adapt the data for a recording medium, and;
(c) recording the processed data onto the recording medium in response to a user command.

A feature of the present invention is the inclusion of promotional data content within the image data stream itself.

One advantage of the present invention is that the present invention allows flexibility for preparation of suitable promotional materials at the motion picture theater itself, both for current and upcoming features.

A second further advantage of the present invention is that the present invention allows the theater owner to offer customers a range of promotional items related to a film showing, yet without the need to stock and manage substantial amounts of inventory.

Yet another advantage of the present invention that it allows the theater owner to provide promotional items related to a motion picture that can be customized for the individual consumer.

These features and advantages, and others of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic block diagram showing a conventional prior art system for motion picture film preparation and distribution.

FIG. 2 is a schematic block diagram showing an exemplary system for mastering and providing digital motion picture data for implementing the present invention.

FIG. 3 is a block diagram showing an arrangement of output devices provided for generation of promotional items at a movie theater.

FIG. 4 is a block diagram showing major data components of an image data stream that provides the image data including both recordable and non-recordable segments;

FIG. 5 is a block diagram showing components used to extract and record data from the image data stream;

FIG. 6 is a block diagram of a kiosk for selection, payment, and customization, according to the present invention; and,

FIG. 7 is a plan view showing typical interface screens provided on the kiosk.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

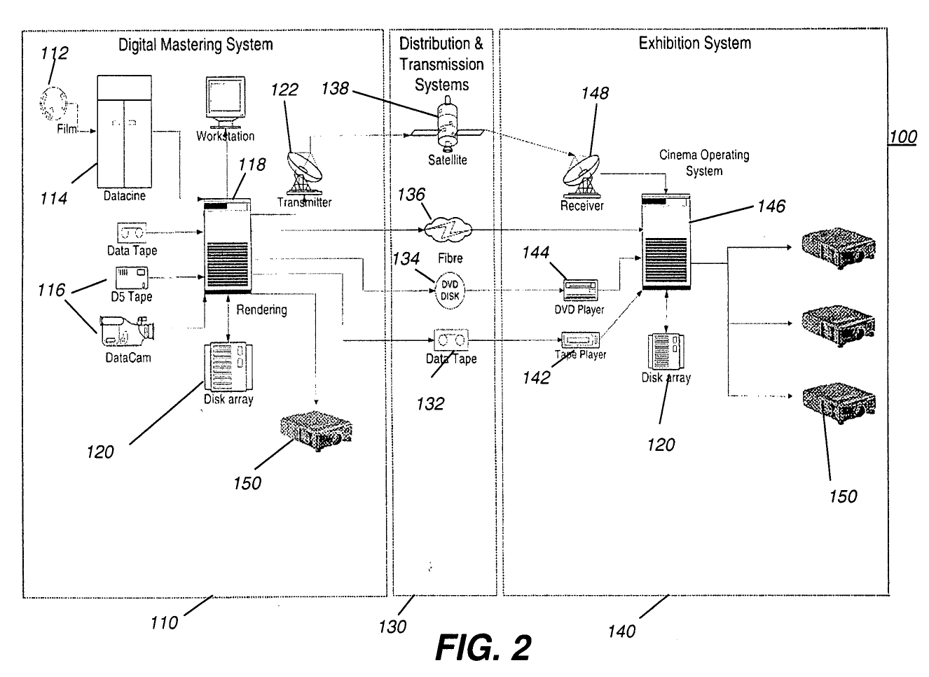

One of the potential benefits of digital cinema relates to how images are stored and displayed from data. Referring to FIG. 2, there is shown a block diagram of a digital cinema preparation and distribution system 100, according to the present invention, for providing motion picture images from a studio 110, over a transmission system 130 to an exhibition system 140, typically a movie theater. The movie theater resides at an exhibition site. The exhibition site includes the lobby, the display screens and projection devices, gaming areas, dining facilities and refreshment stands, and exit/entrance areas and anticipated extended areas proximate to the theater. These areas are well known to those skilled in the art and those that view movies at these exhibition sites. At studio 110, digital mastering is performed on film 112 that contains image content, such as the film feature, advertising, trailers, live video feeds, and the like. A datacine system 114 transforms the film content into digital image content and provides the digital image content to a rendering system 118, typically supported by a disk array 120, that renders the motion picture image data in a resolution suitable for distribution and display. Rendering system 118 may also accept input from auxiliary input devices 116 such as data tape, DS tape, and DataCam devices. The fully mastered digital cinema output then is provided as a data stream to transmission system 130, which may utilize a satellite 138 in communication with a transmitter 122 connected to studio 110 equipment. Other alternative transmission media include a fiber cable connection 136, or transmission using an optical medium 134, such as DVD or optical disks, or using a magnetic medium 132, such as data tape, or using some other type of medium. At exhibition system 140, the mastered digital image data is received, such as at a receiver 148, an optical media reader 144, a magnetic media reader 142 or over a data or fiber optic cable connection 136. A cinema operating system 146, typically supported by disk array 120 or some other mass data storage apparatus using electronic, optical, magnetic, or other types of storage media, accepts the digital input data, processes the input data stream for presentation; and provides this data for image forming and projection by one or more electronic projectors 150.

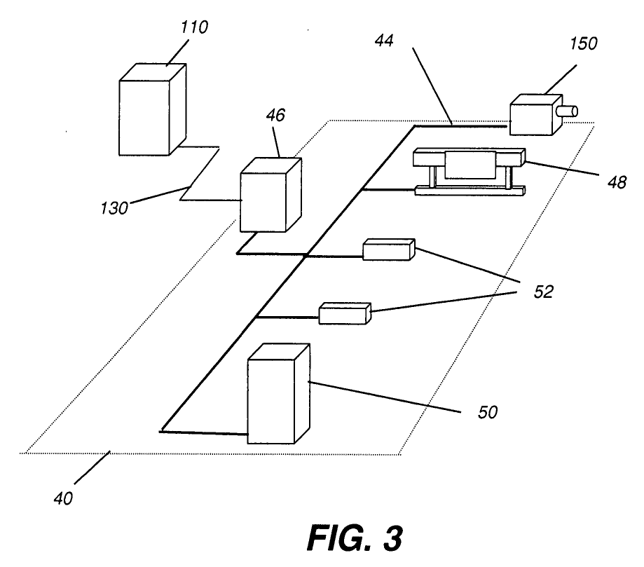

Referring to FIG. 3, there is an entertainment system 40 shown, according to the present invention, configured for the exhibition system 140 of FIG. 2. A control logic processor 46, which may be a separate computer or microcomputer or may be identical with cinema operating system 146, accesses transmitted data that has been provided over transmission system 130 and that is typically stored by means of some mass data storage apparatus, as described hereinabove with reference to FIG. 2. Control logic processor 46 connects along a network 44 to electronic projector 150 and to one or more output devices. The output devices are for recording a supplemental portion of the transmitted data onto an item of some type for forming a promotional item. Output devices may include one or more recording apparatus 52, a large-format printer 48, or other devices, including output devices associated with a kiosk 50. The promotional item can be recorded onto any of a number of types of media, including, but not limited to, optical and magnetic media, textiles, paper, ceramics, and plastics, for example.

Large-format printer 48 may be an inkjet, thermal, laser, or other type of printer suited for printing posters and banners, for example. With this capability, a theater owner can print promotional posters on-site. This would allow the theater owner to print and use an appropriate number of posters or banners for a site, depending on available wall space, audience interest, and timing, for example. The theater owner also has the opportunity to print and sell posters to consumers. Even though it may take several minutes to prepare a large-scale print, posters can be printed at the presentation site during idle time, such as during a showing, so that prints are ready for sale at the end of the event. Posters may be standard posters prepared under the control of studio 110 or, optionally, may be customized, such as using kiosk 50 capabilities, described subsequently.

Recording apparatus 52 may be any of a number of different types of devices for providing images, for recording audio data, or for copying software, or for recording image data, for example. A color printer, such as a thermal printer or photographic printer, could be employed to provide 8×10 prints or printed material in other useful formats. Recording apparatus 52 may also be a printer for writing coupons, tickets, or other appropriate materials. Recording apparatus 52 could be a device for recording onto optical media, such as CDs and DVDs for example. This capability would enable the theater owner to provide audio and/or video clips related to the motion picture or to other upcoming attractions. For example, key scenes or music from a film could be available as a promotional item, recorded onto CD or DVD at the site or delivered/transmitted wirelessly as photo messages or text messages that incorporate scene content or supplemental promotional data. One or more trailers or out-takes from existing or upcoming motion pictures could be provided, for printing onto DVD. Video trailers or selected out-takes could be provided for free or at a nominal price, based on promotional needs of a theater or distributor. A trailer, out-take, still images, or other sample segment of a motion picture could be rendered at lower resolution, to enable faster printing of DVDs. Similarly, audio clips could be provided at low cost for promoting music associated with the motion picture. The content included can be selected by the user when a user selection function is enabled.

In another embodiment, recording apparatus 52 is a printer equipped for writing onto T-shirts and other types of wearing apparel. Using an apparatus such as a thermal printer or a thermal transfer from an electro photographic system enables a consumer to obtain a wearable memento of the motion picture immediately before or after a showing, at the motion picture presentation site itself. Other types of recording apparatus 52 could be employed for writing tattoo materials, coffee mugs, and other types of promotional items.

Data Transmittal

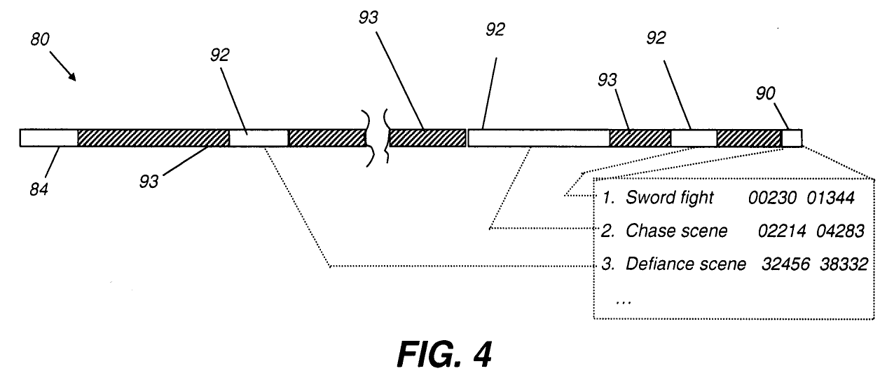

Referring to FIG. 4, there is shown a block diagram of transmitted data 80 sent by studio 110 for a motion picture showing in one embodiment. Transmitted data 80 includes the motion picture data stream that contains the motion picture content from which one or more components can be copied and used to form a promotional product. Wireless transmission of promotional item image data to and from hand-held communication devices such as cellular phones, mobile phones, smart phones, personal digital assistants, pocket personal computers, and other like devices is contemplated as well.

An index 90, typically provided in the header of the motion picture data stream, gives a listing of various recordable portions 92 in the data stream of transmitted data 80 that follows and provides the needed information on type and location of each recordable portion 92. Some percentage of transmitted data 80 may consist of non-recordable portions 93 that cannot be decoded and are thus not available for reproduction at the theater. As the example of FIG. 4 shows, various scenes may be encoded as recordable portions 92, allowing reproduction of image content only, of audio content only, or of both audio and image content.

As these terms are used in this disclosure, the distinction between a recordable portion 92 and a non-recordable portion 93 relates to the encoding that is used. Recordable portion 92 may be encoded for copy protection during transmittal; however, the intended receiving site has access to decoding information for recordable portion 92 content and is thus able to copy and use the data. Recordable portion 92 is, therefore, copyable. In contrast, non-recordable portion 93 is encoded to prevent its copying and re-use. That is, for use by the theater, non-recordable portion 93 is encoded so that it can be displayed, but the image and audio information would not be easy to decode or easily copied. For example, certain scenes because of content or contractual obligations, etc., may be blocked from being recorded and sold. Those skilled in the data encoding arts are familiar with methods for encoding different portions of a data stream in different ways, including providing different levels of encoding protection for different segments of the data stream. Alternatively, there may be no difference in encoding for recordable or non-recordable portions of the motion picture data stream. Additional data or header information can be provided in the digital data stream that classifies an image or scene or audio segment of the motion picture data stream as recordable or non-recordable. In this case, an exhibitor may be contractually bound to produce promotional items only from those segments of the motion picture data stream that are identified as recordable.

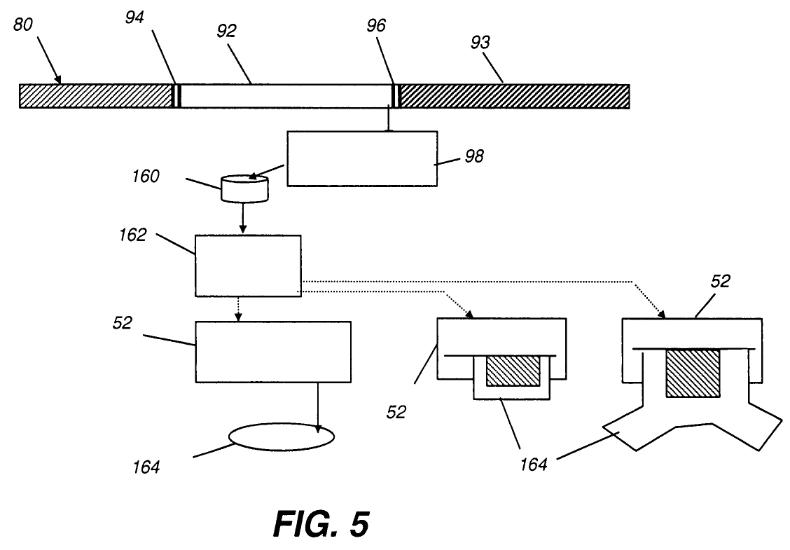

Referring to FIG. 5, there is shown, in block diagram form, the basic mechanisms employed for extracting and reproducing recordable portion 92 in one embodiment. Within the data stream of transmitted data 80, a start code 94 and an end code 96 delineate the beginning and ending locations for one recordable portion 92. Upon detection of start code 94, a reader 98 writes the obtained data into a memory buffer 160. This data can then be recorded by recording apparatus 52. An optional conditioning circuit 162 such as a filter or data converter may be provided to perform some data conditioning function, such as adapting the screen resolution and performing the encoding appropriate for a DVD format, for example. Conditioning circuit 162 may obtain one or more formatting instructions from encoded data in the motion picture data stream. A recording medium 164 could be a CD, DVD, tape cassette, or other data storage device. Optionally, recording medium 164 could be a printer. Using this arrangement, data extracted from the motion picture data stream can be conditioned and re-formatted as necessary, then written to recording medium 164 as needed. The recorded data could include any of the following, singly or in combination, for example:
(i) One or more scenes from the motion picture. This might include a complete scene or some portion of a key scene in the motion picture, suitably conditioned for reproduction onto DVD, tape, or other recording medium 164. This conditioning may include, for example, reducing the resolution from that required for a motion picture display screen to the resolution needed for television viewing. As another option, the recorded data could be the complete movie. Different versions of the movie could be available, with content varied for different age ratings or including and excluding different scenes, providing a long or short version, for example. Audio content or subtitles in many languages could be included. One or more key scenes, such as a chase scene having a specific sound track could be provided.
(ii) One or more images from motion picture content. This could include a “screen capture” still image that can be printed onto a reflective medium such as paper or onto a transparent medium. Images could alternately be printed onto T-shirts or other articles.
(iii) One or more audio sequences from the motion picture. This could include key dialog, the movie theme, or songs and other musical sequences extracted from the movie data stream.

A feedback mechanism, not shown in FIG. 5, could optionally be provided to report back to studio 110 when a scene is recorded at the exhibition site. This type of feedback information could be used for tracking and billing purposes, for example.

In addition to recordable portions 92, as shown in FIG. 4, transmitted data 80 may also include one or more supplemental data components 84 for providing other promotional items along with the transmitted data, including posters, banners, video out-takes, and other items, as disclosed in commonly assigned copending application Ser. No. 10/924,163 described above. Supplemental data components 84 may include instructions for rendering any of the above listed promotional items from images in the motion picture data stream or instructions for creating composite images using elements of a plurality of images or portions of images or audio segments from the motion picture data stream.

Kiosk 50 for Selection and Customization

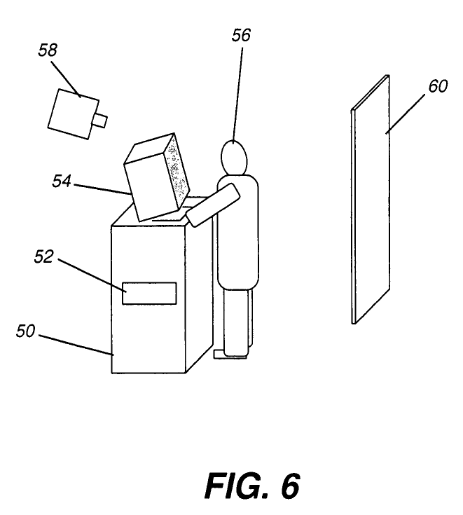

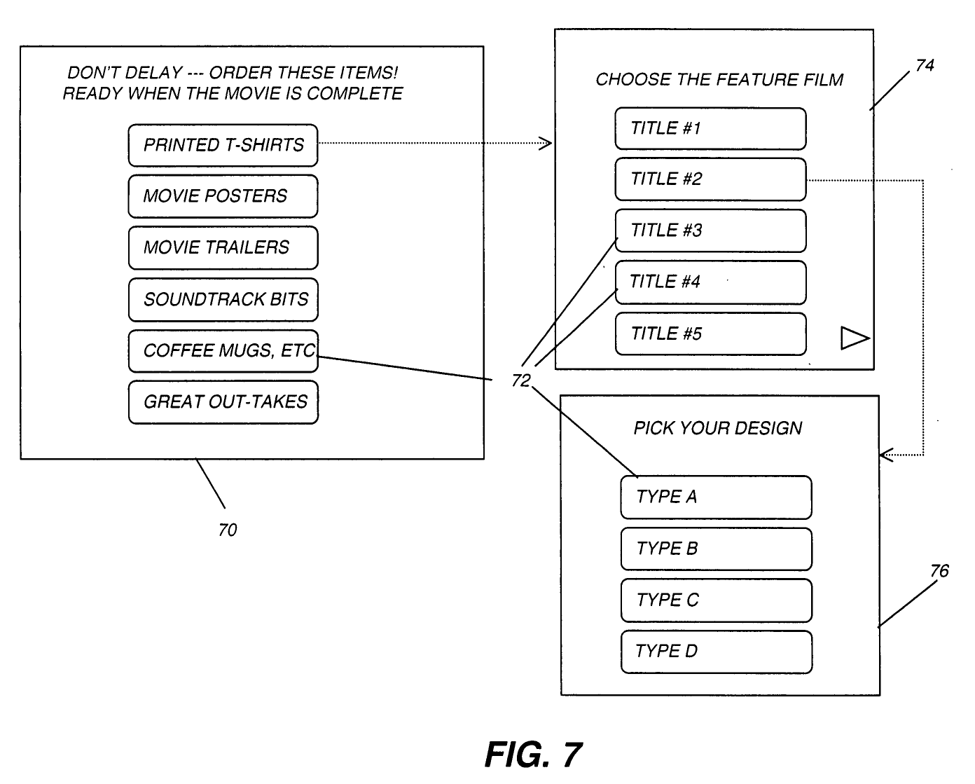

One mechanism for consumer selection of a promotional item is an on-site kiosk or similar order-entry terminal. Referring to FIG. 6, there is shown an arrangement of kiosk 50 in one embodiment. Kiosk 50 can be placed in the lobby at the theater site, and can be operated by a consumer 56 or by theater personnel. Kiosk 50 includes an interface terminal 54 that enables consumer 56 to order any of various promotional items that have been provided within the motion picture data. For example, interface terminal 54 may provide a touch screen menu of selections, as shown in the example screen sequence of FIG. 7. A main menu screen 70 lists options for ordering. The full set of available promotional items can be extensive and may include such items as posters, coffee mugs, iron-on cloth patches and T-shirts of various design, CDs having movie soundtrack or one or more celebrity interviews, songs, or theme segments, or DVDs with one or more scenes from the movie content, for example. Consumer 56 makes a selection by pressing a touch screen button 72 and successively works through additional menu screens 74 and 76 to specify the promotional item ordered. Of course, there are many options for user interface design that would allow customers themselves to specify promotional item type and characteristics and also selections of specific content such as song titles or movie clips as would be familiar to one skilled in the user interface arts. In addition, kiosk 50 may provide non-copyable samples of various promotional items, allowing playback of various video or audio content, allowing a customer to order an item for later shipment. Wireless communication with the kiosk 50 is possible using known means such as Bluetooth™ and future equivalent wireless transmission means.

In other embodiments, kiosk 50 may serve as more than an order station. A camera 58 and display 60 may also be provided as part of the configuration of kiosk 50, allowing consumer 56 to obtain a custom image on a promotional item. For example, camera 58 may obtain an image of the face of consumer 56 for combination with a prepared background that may appear on display 60 or may be stored internally. This would enable consumer 56 to be placed within a scene or costume appropriate to the motion picture. A copy of one or more scenes of a motion picture could be provided to a consumer, custom-tailored so that the consumer is pictured as a participant within the scene in the copy provided.

Transaction Handling

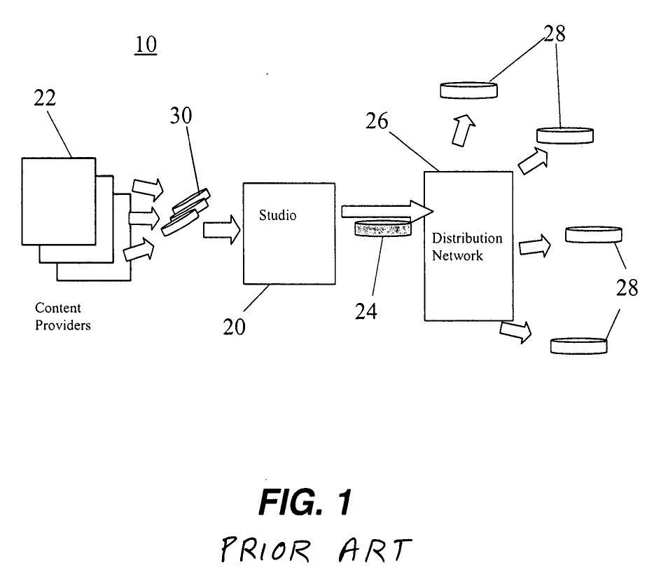

Coupling supplemental data components 84 to transmitted data 80 allows a number of possible arrangements for handling payment. In one embodiment, promotional items used directly as advertising, such as trailers, posters, or small portions of selected scenes or music themes, are printed onto DVD or CD at the theater site and are made available for free to all customers, or to customers who paid at the door, or to those who paid in advance. The expense of providing these items is then borne by studio 110 (FIG. 1) or by a distributor. This type of “free” advertising distributes, to the movie-going public, materials such as selected trailers for upcoming motion pictures.

In another embodiment, theater 28 pays a license fee for reprinting of promotional items from supplemental data component 84. Tracking software is also provided in order to maintain some measure of control in this printing arrangement. In one embodiment, tracking software permits the copying or printing of a limited number of promotional items; attempts to exceed these limits may lead to the requirement to purchase a more expensive license, for example. Tracking software can also be used to report the number of promotional items fabricated in order for studio 110 to obtain some percentage of the profits. Tracking software may contact the supplemental data provider each time an item is created via supplemental data component 84, or may accumulate a particular number of usages before contacting or being queried by the supplemental data provider.

Customer payment can also be obtained in a number of different ways. In one embodiment, consumer 56 pays directly at the kiosk with an electronic transaction, swiping a credit card through a reader after making an order, for example. Some items may be immediately available before or following a showing; others may be shipped to consumer 56 or available for pick-up at a later time. The ticket stub of consumer 56 can also be scanned in a reader to validate a special offer or to obtain an item paid for at the time of ticket purchase. A third-party ticket service, such as http://www.tickets.com, for example, may present a special offer that can be fulfilled by scanning a ticket or other printed item. In yet another embodiment the promotional items may be used as rewards for courtesy card holders. For example, a certificate for a poster or a DVD copy of the movie may be awarded the customer who accumulates a certain number of courtesy card points. A bar code maybe printed on the ticket that can be scanned at the kiosk to receive the poster or DVD.

It can be appreciated that entertainment system 40 of the present invention provides the theater owner with a number of unique advantages for profit and can help to enhance the entertainment experience of consumer 56. The theater owner is not burdened with the task of storing and maintaining inventory of items that can only be profitably sold while a motion picture is shown at the site. For example, instead of ordering hundreds of DVD copies for each movie being shown, the theater owner can stock a reasonable number of DVDs and provide copies of the movie on them, complete with printed labels, as ordered. Moreover, as noted above, the theater can provide copies of different versions, such as by length, by age rating (P, PG, R, etc.), or by other criteria. The consumer, meanwhile, has an opportunity to purchase a promotional item at the theater itself, before, during, or after the showing.

By allowing the theater to extract data from the motion picture data stream for repackaging and resale and for providing various promotional items, the method of the present invention creates additional profit opportunities for both the theater and the film distributor. At the same time, motion picture data can be protected so that unauthorized copying is discouraged. Copy protection software can be added to data recording apparatus 52 in order to make it difficult or impossible to generate unauthorized copies from being made. Copies ordered in advance, such as at the time of ticket sale, can be time-stamped and otherwise encoded to identify the purchasing consumer, as a forensic aid in determining the source of an illegal copy.

The method of the present invention allows a studio to identify one or more portions of a motion picture data stream that can be recorded, copied, and distributed from a theater or other exhibition site. Other content, identified as non-recordable portions 93 can be protected from reproduction at the theater. With this mechanism, a studio or distributor retains control and ownership of the overall content, such as using data encoding schemes, but allows selective access to some portions of the content, such as for promotional purposes.

What is provided herein are exemplary methods and apparatuses for using parts of the data stream of a motion picture to promote sales of supplemental movie-related items.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, a person of ordinary skill in the art may implement portions of the present invention for “live” shows such as theater productions, circus productions, and skating productions.

### Parts List

10 Motion picture film distribution system
20 Studio
22 Content providers
24 Print film
26 Distribution network
28 Theater
30 Content films
40 Entertainment system
44 Network
46 Control logic processor
48 Large-format printer
50 Kiosk
52 Recording apparatus
54 Interface terminal
56 Consumer
58 Camera
60 Display
70, 74, 76 Menu screen
72 Touch screen button
80 Transmitted data
82 Motion picture component
84 Supplemental data component
90 Index
92 Recordable portion
93 Non-recordable portion
94 Start code
96 End code
98 Reader
100 Digital cinema preparation and distribution system
110 Studio
112 Film
114 Datacine system
116 Auxiliary input devices
118 Rendering system
120 Disk array
122 Transmitter
130 Transmission system
132 Magnetic medium
134 Optical medium
136 Fiber cable connection
138 Satellite
140 Exhibition system
142 Magnetic media reader
144 Optical media reader
146 Cinema operating system
148 Receiver
150 Digital projector
160 Memory buffer
162 Conditioning circuit
164 Recording medium

What is claimed is:

1. A method for providing, at an exhibition site, a promotional item formed using motion picture data, the method comprising the steps of:
(a) receiving a motion picture data stream at the exhibition site, wherein the data stream is encoded to define at least one recordable portion;
(b) storing the at least one recordable portion of the motion picture data stream at the exhibition site;
(c) forming the promotional item according to the at least one recordable portion of the data stream, in response to a user command.

2. A method according to claim 1 wherein the step of forming the promotional item comprises the step of recording onto a CD.

3. A method according to claim 1 wherein the step of forming the promotional item comprises the step of recording onto a DVD.

4. A method according to claim 1 wherein the step of forming the promotional item comprises the step of recording onto a magnetic tape.

5. A method according to claim 1 wherein the step of forming the promotional item comprises the step of recording onto a fabric.

6. A method according to claim 1 wherein the at least one recordable portion comprises an image.

7. A method according to claim 1 wherein the at least one recordable portion comprises an audio sequence.

8. A method according to claim 1 wherein the at least one recordable portion comprising an image sequence is matched to a specific audio sequence.

9. A method according to claim 1 wherein the at least one recordable portion comprises at least one subtitle specified by the user from a set of subtitles, according to language.

10. A method according to claim 1 wherein the step of forming the promotional item comprises the step of obtaining a language preference from the user.

11. A method according to claim 1 wherein the step of forming the promotional item comprises the step of forming a composite image.

12. A method according to claim 11 wherein the step of forming a composite image further comprises the step of recording audio segments related to the composite image.

13. A method of selective encoding of a motion picture data stream, comprising the steps of identifying at least one recordable segment of the data stream and identifying at least one non-recordable segment of the data stream.

14. A method according to claim 13 further comprising the step of providing a data index listing the at least one recordable segment of the data stream.

15. A method for providing a copy of a motion picture, comprising the steps of:
(a) receiving a motion picture data stream at an exhibition site, wherein the data stream is encoded to define a plurality of recordable scenes;
(b) processing the data for the plurality of recordable scenes from the data stream to adapt the data for a recording medium; and,
(c) recording the processed data onto the recording medium in response to a user command.

16. A method according to claim 15 wherein the step of processing the data comprises the step of obtaining a language preference from a user.

17. A motion picture data stream comprising at least one scene encoded to permit recording and at least one other scene encoded to be copy-protected.

18. The motion picture data stream according to claim 15 further comprising encoding that provides data formatting and rendering instructions for the at least one scene to be recorded.

19. The motion picture data stream claimed in claim 17, wherein the motion picture data stream is transmitted to hand-held communication devices.

20. A kiosk for selection of promotional items that use motion picture data, comprising:
(a) an interface terminal for selecting available promotional items; and
(b) a menu including options for selecting the available promotion items.

21. The kiosk claimed in claim 20, further comprising:
(c) a plurality of samples of the available promotional items.

22. The kiosk claimed in claim 21, wherein the samples include video or audio content correlating to the motion picture data.

23. The kiosk claimed in claim 20, further comprising:
(c) a camera for capturing an image of a customer;
(d) a display for displaying the captured image of the customer;
(e) means for including the captured image of the customer with the promotional item.

24. The kiosk claimed in claim 20, further comprising:
(c) means for communicating with the kiosk remotely.

25. The kiosk claimed in claim 20, wherein the means for communicating include wireless transmission means.

26. A method for colinking motion picture data with sales transactions of promotional items associated with the motion picture data, comprising the steps of:
(a) employing tracking software for controlling fabricating and/or printing of the promotional items; wherein controlling fabricating and/or printing of the promotional items includes one or more of the steps:
a1) limiting a total amount of copying or printing of the promotional items;
a2) reporting number of promotional items fabricated;
a3) contacting a supplemental data provider each time a promotional item is created; and
a4) accumulating usage data prior to contact with the supplemental data provider.

27. The method claimed in claim 26, wherein customer payment is obtained in any one of or a combination of the following steps, including:
(a) accepting payment directly at a kiosk for ordering promotional items;
(b) scanning a ticket of a customer for payment or special promotional offer validation; and
(c) employing an internet website for fulfilling a promotional order.

28. The method claimed in claim 1, further comprising the step of:
(d) receiving customer requests from a kiosk having selections correlating to the promotional item.

29. The method claimed in claim 1, further comprising the step of:
(d) receiving customer requests from a handheld communication device having selections correlating to the promotional item.
